(19) United States
(12) Patent Application Publication
(10) Pub. No.: US 2006/0167626 A1
(43) Pub. Date: Jul. 27, 2006

(54) Navigation system and program for controlling the same

(75) Inventor: Masayuki Hashizume, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/332,354

(22) Filed: Jan. 17, 2006

(30) Foreign Application Priority Data
Jan. 24, 2005 (JP) 2005-015601

(51) Int. Cl. G01C 21/34

(52) U.S. Cl. 701/210; 701/209; 340/995.21

(57) ABSTRACT

A navigation system includes a congestion information acquisition function, a congestion determination function, a speed determination function, a calculation function, and a display function for navigating a vehicle. The navigation system uses these functions for determination of traffic congestion on a road and for calculation of an alternative route to a destination.

### CROSS REFERENCE TO RELATED APPLICATION

This application is based on and claims the benefit of priority of Japanese Patent Application No. 2005-15601 filed on Jan. 24, 2005, the disclosure of which is incorporated herein by reference.

### FIELD OF THE INVENTION

The present invention generally relates to a navigation system.

### BACKGROUND OF THE INVENTION

Conventionally, a navigation system for use in a vehicle receives traffic congestion information through radio communication or the like, and utilizes the acquired information for calculation of route guidance. Japanese patent document JP-A-H7-63566 discloses a navigation system that uses an above-described scheme.

The traffic congestion information provided for the navigation system in the vehicle is collected by using a road-side sensor that detects quantity and speed of traffic passage, and is prepared for provision for the vehicle from a road-side device or the like.

However, the road-side sensor is usually disposed above a main lane of a road, thereby detecting only the vehicle on the main lane of the road. Therefore, the traffic congestion information may not correctly reflect actual situation of traffic passage because of the position of the road-side sensor above the main lane. That is, there may be a situation that the vehicle in waiting in a right/left turn lane can not be detected by the sensor on the main lane, and thereby giving false traffic congestion information.

FIG. 3 shows an illustration of a road for an explanation of an above-described situation. In this illustration, an intersection 51 has a one-way traffic incoming from a road 52 that includes two additional lanes 57, 58 in a proximity of the intersection 51 in addition to four main lanes 53, 54, 55, 56, and four sensors 63, 64, 65, 66 are disposed above the four main lanes 53, 54, 55, 56 for detecting the number of the vehicles and the speed of the vehicles on each of the four lanes.

The sensors 63, 64, 65, 66 are capable of detecting a traffic congestion and transmits traffic congestion information that informs that the traffic on the road 52 is congested when the main lanes 53, 54, 55, 56 are occupied by very slow traffic. However, in this case, the vehicles in waiting on the additional right turn lane 57 cannot be detected by the sensors 63, 64, 65, 66. That leads to the traffic congestion information that informs that the traffic on the road 52 is not congested.

The traffic congestion information provided for the navigation system for use in calculation of an optimum route to a destination may cause a problem when the traffic congestions information does not include information on traffic congestion in a specific lane in a portion of the optimum route.

The problem caused by the traffic congestion in the optimum route may be worked around in the following manner. That is, the navigation system disclosed in the Japanese patent document JP-A-H7-63566 proposes acquisition of the information on the additional lanes for use in the calculation of the optimum route. However, the acquisition of traffic congestion in the additional lanes is very costly when additional sensors are used for acquisition of the information. Therefore, the calculation of the optimum route is preferably be managed on the navigation system side.

### SUMMARY OF THE INVENTION

In view of the above-described and other problems, the present invention provides a navigation system that can detect traffic congestion in a specific lane for calculation and display of an optimum route having no traffic congestion even when available traffic congestion information does not include the information on the traffic congestion of the specific lane.

The navigation system of the present invention includes following functions for calculation of an alternative route when a part of a navigation route originally calculated is congested. The navigation system in a subject vehicle uses nodes and links that connects the nodes in map data for representation of the navigation route. That is, a congestion information acquisition function for acquiring information of traffic congestion in a link, a first determination function for determining one of following two conditions, a first condition that the information of traffic congestion of a current link where the subject vehicle is traveling is acquired by the congestion information acquisition function, and a second condition that the information of traffic congestion of the current link has not been acquired. Required functionality of the navigation system further includes a second determination function for determining traveling condition of the subject vehicle in the current link in a predetermined range of speed, a calculation function for calculating the alternative route toward the destination from an end node of the current link and a display means for displaying the alternative route on a display device based on combination of determinations by the first determination means and the second determination means.

In this case, the end node of the current link is a node that the subject vehicle is expected to turn to the right/left when the subject vehicle follows the navigation route to the destination. Further, the predetermined range of speed used in the second determination function may be defined, for example, as a speed of less than 5 cm per minute. The speed may be a speed at an instance or an average of speed for a period.

The navigation system detects the traffic congestion of the current link in the navigation route based on the conditions that (1) acquisition of no traffic congestion information in the current link toward the end node (i.e., an intersection of a road), or no acquisition of traffic congestion information in the current link, (2) the speed of the subject vehicle is lower than the predetermined value even when the traffic information on a specific lane of a road is not available. Therefore, the navigation system can detect the traffic congestion of the specific lane and can calculate/display the alternative route to avoid the congestion even when the traffic information does not reflect the congestion.

The navigation system further includes a position determination function for measuring a distance from the end node of the current link (distance from the intersection). In this manner, the navigation system may display the alternative route on the display device when it is appropriate based on determination of the distance from the intersection, the speed of the vehicle and the condition of the traffic in a proximity of the intersection.

The distance from the intersection may be, for example, 30 to 50 meters. In this manner, the navigation system avoids unnecessary proposition of the alternative route when the subject vehicle is too closed to the intersection for lane change.

The navigation system may select the alternative route to the destination as a new navigation route before the subject vehicle departs from the original navigation route. In this manner, the navigation system can start guidance for the new navigation route before the subject vehicle departs from the original navigation route.

The navigation system of the present invention may be implemented as a computer program that is functional as the functions described above.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in an embodiment of the present invention;

FIG. 2 shows a flowchart of a detour calculation process; and

FIG. 3 shows an illustration of an intersection and a road of plural lanes.

### DETAILED DESCRIPTION OF THE PREFERRED EMBODIMENT

An embodiment of the present invention is described with reference to the drawings. This navigation system of the present invention is intended for use in a subject vehicle such as an automobile or the like.

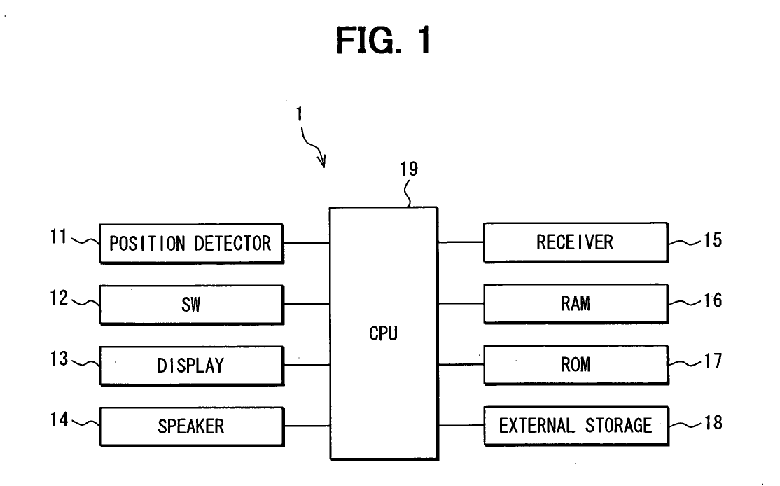

FIG. 1 shows a block diagram of the navigation system in the embodiment of the present invention. The navigation system 1 includes a position detector 11, operation switches 12, an image display device 13, a speaker 14, a traffic information receiver 15, a RAM 16, a ROM 17, an external storage 18, and a CPU 19.

The position detector 11 includes a plurality of sensors such as a geomagnetism sensor, a gyroscope, a speed sensor, a Global Positioning System (GPS) receiver, and the like (not shown in the figure). The position detector 11 outputs information on a current position and a direction of traveling of the subject vehicle to the CPU 19 based on data from the sensors mentioned above.

The operation switches 12 include a plurality of mechanical switches on the navigation system 1, a touch panel or the like disposed on a display portion on the image display device 13, and outputs signals to the CPU 19 based on a press of a mechanical switch, a touch on the touch panel by a user.

The image display device 13 displays an image for the user based on an image signal outputted from the CPU 19. For example, the image display device 13 displays a map around a current position of the subject vehicle.

The traffic information receiver 15 receives traffic information on congestion or the like through FM broadcasting and/or other communication provided from a roadside device, and outputs data to the CPU 19. In this case, the traffic information on congestion is data that is used to relate actual traffic congestion on a road and relevant links in map data.

The external storage 18 is nonvolatile storage medium such as a hard disk drive (HDD), and memorizes map data for route guidance and programs to be executed by the CPU 19.

Map data includes positions, types, connection information of a node (four forks road, a three-way intersection, crossroads, a junction) and a link as well as facility data.

The CPU 19 executes a program stored in the ROM 17 and/or the external storage 18 for operation of the navigation system 1 by using information in the RAM 16, the ROM 17 and the external storage 18 as well as writing information to the RAM 16 and the external storage 18. The CPU 19 exchanges signals with the position detector 11, the operation switches 12, the image display device 13, the speaker 14, and the traffic information receiver 15.

More practically, the CPU 19 executes a current position detection process, a congestion information acquisition process, a route search process, a route guidance process and the like.

The current position detection process determines a current position, a direction of traveling of the subject vehicle based on signals derived from the position detector 11 by using a map matching process of well-known type or the like.

The congestion information acquisition process repeats storage of the traffic information on congestion received through the traffic information receiver 15 in the RAM 16 or the external storage 18.

The route search process searches an optimum route from the current position to a destination based on map data in the external storage 18 and the traffic information from the traffic information receiver 15 upon having an input of the destination through the operation switches 12 by the user.

The route guidance process retrieves the map data from the external storage 18, outputs a map image having the optimum route contained therein to the image display device 13, outputs, when necessary, a guidance signal to the speaker 14 for executing sound guidance that instructs the user to turn right/left at a guidance point (an approaching intersection, or a node in the map data).

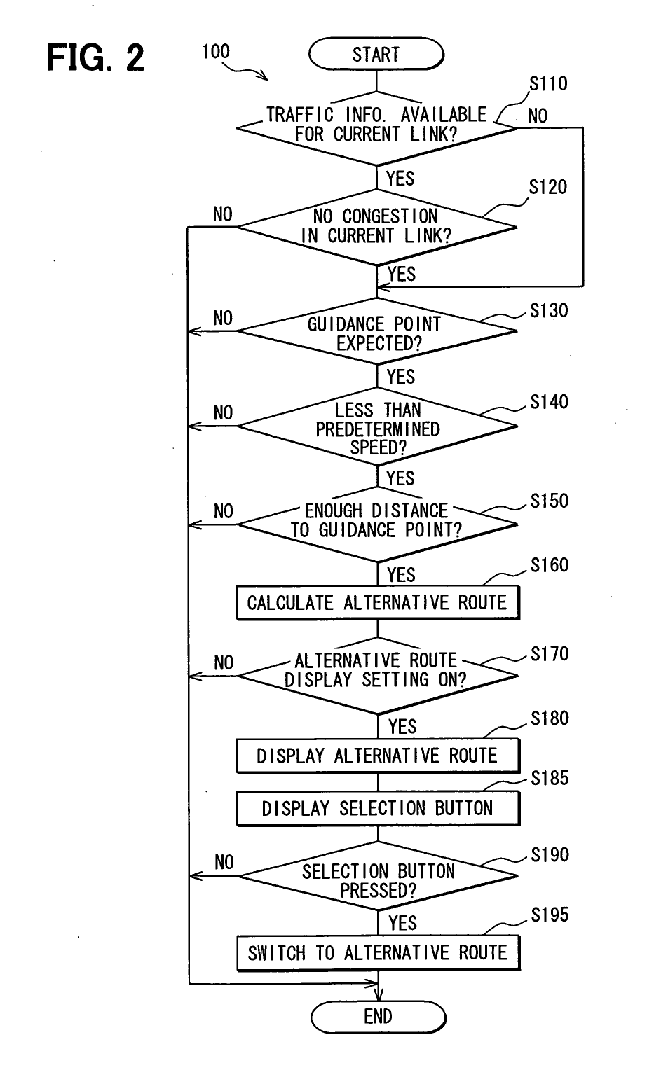

The CPU 19 repeatedly executes an alternative route display program 100 illustrated as a flowchart of a process in the program 100 in FIG. 2.

In step S110, the process determines whether the traffic information on congestion of currently passing section of a road (a current link) is available from the traffic information receiver 15. That is, the process checks the traffic information on congestion of the current link is stored in the RAM 16 and/or the external storage 18 by the congestion information acquisition process. The process proceeds to step S120 when the traffic information on congestion is available, and the process proceeds to step S130 when the information is not available.

In step S120, contents of the traffic information on congestion stored by the congestion information acquisition process is determined. When the content of the traffic information indicates that the current link is not congested, the process proceeds to step S130. The alternative route display program 100 concludes when the content of the traffic information indicates that the current link is congested.

In step S130, the process determines whether a next node in a navigation route is a guidance point. That is, a node to be passed at an end of the current link is called as the “next node.” The process proceeds to step S140 when the next node is the guidance point, and one cycle of execution of the program 100 concludes when the next step is not the guidance point.

In this manner, the process determines either the current link is not congested or the traffic information on the current link is not available, and executes step S140. One cycle of execution of the program 100 concludes when situation is differently determined.

In step S140, an average speed of the subject vehicle is determined. That is, the average speed of the subject vehicle is compared with a predetermined value of speed for determination. The average speed may be a value of a couple of centimeters per minute or the like. The average speed may be an average of the speed of the subject vehicle over, for example, one minute or the like prior to a current moment. The process proceeds to step S150 when the average speed of the subject vehicle is less than the predetermined value, and one cycle of execution of the process concludes when the average speed is determined otherwise.

In step S150, the distance from the subject vehicle to the next node, i.e., the guidance point is determined. That is, the distance to the next node is compared with a predetermined value for consideration whether the subject vehicle can safely change lanes, when the subject vehicle reaches the next node (the intersection) or the like. The predetermined value may be, for example, 30 meters or the like, that is, the distance equal to a couple of, or tens of the length of the subject vehicle. The process proceeds to step S160 when the distance is greater than the predetermined value, and one cycle of execution of the program 100 concludes when the distance is determined otherwise.

In step S160, the process calculates the alternative route. That is, the alternative route from the intersection 51 to the destination is calculated differently from the current navigation route for optimally navigating the subject vehicle.

In step S170, the process determines whether an alternative route display setting is ON. The alternative route display setting is determined to be ON based on an alternative route display setting flag in the external storage 18. The flag can be changed according to an operation of the operation switches 12 by the user. The process proceeds to step S180 when the alternative route display setting flag is ON, and one cycle of execution of the program 100 concludes when the flag is not ON.

In step S180, the process displays the map image including the alternative route calculated in step S160 on the image display device 13. The current route of navigation may also be included in the map image. The map image may be accompanied by sound guidance such as “an alternative route is displayed,” or the like outputted from the speaker 14.

In step S185, the image display device 13 displays an alternative route selection button in the map image having the alternative route.

In step S190, the process determines whether the alternative route selection button is pressed. More practically, the process waits for an input of selecting the alternative route selection button from the operation switches 12 by the user for a predetermined amount of time (e.g., for 30 seconds), and the process proceeds to step S195 upon receiving the input from the switches 12. One cycle of execution of the program 100 concludes when there is no input for the predetermined amount of time. The input from the operation switches 12 includes a selection operation by the mechanical switch among the switches 12 for locating a cursor in the area of the button, or a touch in an area of the button on the touch panel of the switches 12.

In step S195, the process switches the current navigation route to the alternative route. In this manner, the process begins to navigate the user and the subject vehicle by using the alternative navigation route. One cycle of execution of the alternative route display program 100 concludes when step S195 is complete.

In addition, the process may stop the execution of the alternative route display program 100 until the subject vehicle passes the guidance point when the alternative route selection button is not pressed in step S190. In this manner, unnecessary repetition of route guidance of the alternative route from the guidance point that is already being recognized by the user is prevented.

Further, the alternative route may consequently become a new navigation route even when the alternative route selection button is not selected. That is, when the user of the navigation system 1 drives away from the original navigation route, the alternative route may be prepared and presented when an auto-reroute function of well-know type is in use.

The alternative route display program 100 is executed by the CPU 19 for controlling the navigation system 1 to calculate the alternative navigation route from the next guidance point (i.e., the next node) (step S160) on conditions that one of (A) the traffic information on congestion of the current link is not available and (B) the traffic information on congestion of the current link indicates that the link is not congested (steps in S10 or S120) is fulfilled and, the next node is the guidance point (step S130) and, the vehicle is traveling at equal to or less than the predetermined average speed (step S140) and, the distance to the guidance point is equal to or greater than the predetermined value (step S150). Further, the program 100 displays the map image with the alternative route and the alternative route selection button based on the predetermined setting by the user for accepting the user input from the image display device 13 (steps S170 to S185). The program 100 switches the navigation route to the alternative one when the user input selects the alternative route (step S190).

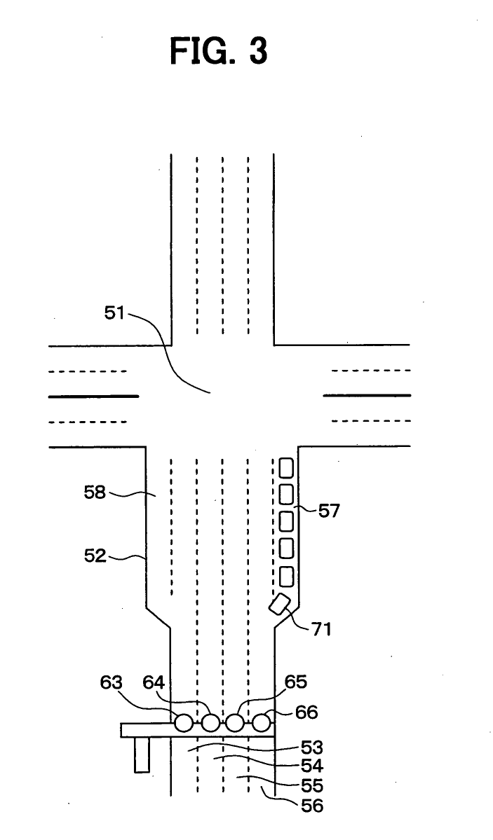

A situation in an illustration in FIG. 3 shows that the navigation system 1 is originally displaying a navigation route that enters the intersection 51 for turning right to the destination. In this case, the traffic information reflects the congestion only in the lanes of 53 to 56, and an actual congestion is occurring in the right turn lane 57. The subject vehicle 71 caught in the congestion in the lane 57 executes the alternative route display program 100 for displaying the alternative route based on the above-described conditions. That is, the conditions includes that the current link is not congested (step S120), the next node is the guidance point (step S130), the average speed is equal to or less than the predetermined value (step S140), and the distance to the guidance point is equal to or greater than the predetermined value (step S150). The alternative route may be a route that goes straight through the intersection 51, or a route that turns left at the intersection 51. The alternative route is displayed on the map image in step S180 when the alternative route display setting is ON, and the alternative route selection button is displayed in step S185. The alternative route is replaced with the current route in step S195 when the alternative route selection button is selected by the user. The alternative route calculation in step S160 and the following steps (alternative route display/switching old route to new) will not be executed when the distance to the guidance point is less than the predetermined value.

The navigation system 1 can detect the traffic congestion of the currently passing lane in the road and can calculate the alternative route from the next guidance point to the destination based on the no congestion information/absence of traffic information, the average speed of the vehicle, and the distance from the guidance point even when the available traffic information does not indicates the congestion of the currently passing lane. Therefore, the navigation system 1 can avoid the traffic congestion of a specific lane and display the alternative route when the traffic information does not reflect the traffic congestion of the specific lane.

Further, the navigation system 1 does not provide the alternative route unnecessarily when the distance to the subject vehicle is too close to the intersection (the guidance point) based on the consideration that lane change in a proximity of the intersection is unsafe.

Furthermore, the navigation system 1 switches the original navigation route to the alternative route before the subject vehicle departs from the original navigation route upon receiving the selection input from the user. Therefore, the route guidance for avoiding the congestion that is not included in the traffic information can be started while the subject vehicle is traveling in the original navigation route.

Although the present invention has been fully described in connection with the preferred embodiment thereof with reference to the accompanying drawings, it is to be noted that various changes and modifications will become apparent to those skilled in the art.

For example, the process of the program 100 may be executed in the following manner. That is, the determination in step S110 and the determination in step S120 may be exclusively executed before executing the step S130.

Further, step S180 may be executed after step S160 and before step S170. That is, the alternative route may be displayed immediately after the calculation of the alternative route.

Furthermore, steps S170, S185 and S190 may be skipped. That is, the alternative route may be displayed upon calculation and used in step S195. The alternative route may be automatically calculated and used, or may be used upon receiving the user input. The automatic calculation/use and the manual use may be selectively determined by the user.

Furthermore, the average speed may be calculated over a period that is longer than a maximum signal wait time (e.g., two minutes) in step S140.

Furthermore, the alternative route may be calculated before the subject vehicle enters into the link that ends at the guidance point. That is, for example, the alternative route may be calculated immediately after the calculation of the original navigation route.

Furthermore, the traffic condition on congestion may be determined as not congested in step S120 even when some of the plural lanes are congested, or when the lane included in the navigation route is not congested.

Furthermore, the navigation system 1 may be disposed and used in a vehicle, or may be held and used by a human being.

Such changes and modifications are to be understood as being within the scope of the present invention as defined by the appended claims.

What is claimed is:

1. A navigation system for use in a subject vehicle that organizes a navigation route toward a destination by connecting nodes with links in map data as a route guidance comprising:
a congestion information acquisition means for acquiring information of traffic congestion in a link;
a first determination means for determining one of following two conditions of the subject vehicle, wherein the information of traffic congestion of a current link where the subject vehicle is traveling is acquired by the congestion information acquisition means as a first condition, and the information of traffic congestion of the current link has not been acquired as a second condition;
a second determination means for determining that traveling speed of the subject vehicle in the current link is within a predetermined range of value;
a calculation means for calculating an alternative route toward the destination from an end node of the current link; and
a display means for displaying the alternative route on a display device based on combination of determinations by the first determination means and the second determination means.

2. The navigation system according to claim 1 further comprising:
a position determination means for determining that quantity of remoteness of the subject vehicle from the end node of the current link is within a predetermined range,
wherein the display means displays the alternative route toward the destination based on combination of determinations by the first determination means, the second determination means and the position determination means.

3. The navigation system according to claim 2 further comprising:
a switching means for switching the route guidance from the navigation route to the alternative route being displayed on the display device,
wherein the switching means switches the route guidance to the alternative route before the subject vehicle departs from the navigation route.

4. A computer program stored in a computer-readable medium having computer program logic recorded thereon for enabling control of a navigation system that organizes map data including a plurality of nodes and connecting links for route guidance comprising:
a congestion information obtaining procedure for obtaining information of traffic congestion in a link;
a first determination procedure for determining one of following two conditions, wherein the information of traffic congestion of a current link where the subject vehicle is traveling has been obtained by the congestion information obtaining procedure as a first condition, and the information of traffic congestion in the current link has not been obtained as a second condition;
a second determination procedure for determining that traveling speed of the subject vehicle in the current link is in a predetermined range of value;
a calculation procedure for calculating an alternative route toward the destination from an end node of the current link; and
a display procedure for displaying the alternative route on a display device based on combination of determinations by the first determination procedure and the second determination procedure.

5. A method for controlling a navigation system in a vehicle for route navigation that leads to a destination through a guidance point comprising steps of:
obtaining either traffic information on congestion in a section of a navigation route or absence of the traffic information;
detecting speed of the vehicle;
calculating an alternative route toward the destination; and
displaying the alternative route on a display device,
wherein the alternative route is displayed on the display device when determinations in the steps indicates that the traffic information on congestion indicates one of no congestion in the section of the navigation route and absence of the traffic information, and that the speed of the vehicle is within a predetermined range of value.

6. The method according to claim 5 further comprising a step of:
determining a distance from the vehicle to the guidance point,
wherein the alternative route is displayed on the display device when the distance is equal to or greater than a predetermined range of value.

7. The method according to claim 6 further comprising a step of:
switching the navigation route to the alternative route,
wherein the navigation route is switched to the alternative route before the vehicle departs from the navigation route.
